(19) United States
(12) Patent Application Publication
(10) Pub. No.: US 2025/0286848 A1
(43) Pub. Date: Sep. 11, 2025

(54) INFORMATION COMMUNICATION DEVICE AND INFORMATION COMMUNICATION PROGRAM

(71) Applicant: Saga University, Saga-shi (JP)

(72) Inventor: Koichi NAKAYAMA, Saga-shi (JP)

(21) Appl. No.: 19/068,004

(22) Filed: Mar. 3, 2025

(30) Foreign Application Priority Data
Mar. 11, 2024 (JP) 2024-037637

(51) Int. Cl. H04L 51/212; G06Q 10/107; G06Q 20/06

(52) U.S. Cl. CPC H04L 51/212; G06Q 10/107; G06Q 20/065; G06Q 2220/00

(57) ABSTRACT

An information communication device is disclosed. The device includes: an email sending unit that sends an email from one account to another account; a remittance control unit that generates a remittance transaction for sending cryptocurrency from the one account to the another account when sending the email and broadcasts it to a blockchain; an email receiving unit that receives an email sent from another account to the one account; a reception control unit that accesses, when receiving the email, the blockchain to confirm a status of cryptocurrency from the another account to the one account and identifies the received email as a legitimate email when a deposit amount confirmed is not less than a predetermined threshold; a refund control unit that refunds cryptocurrency when the received email is identified as the legitimate email; and a threshold control unit that adjusts the threshold depending on a type of the received email.

### CROSS REFERENCE TO RELATED APPLICATIONS

This application claims the benefit of priority of Japanese Patent Application No. 2024-037637, filed on Mar. 11, 2024, the contents of which are incorporated by reference as if fully set forth herein in their entirety.

### TECHNICAL FIELD

The present invention relates to information communication devices and programs for preventing spam attacks in emails.

### BACKGROUND ART

Emails sent in large quantities to an unspecified number of email addresses (hereinafter referred to as “spam emails”) are an annoying presence for email users. A user who sends a large quantity of spam emails (hereinafter referred to as a “spammer”) sends a large quantity of spam emails to an unspecified number of email addresses for various purposes such as advertising, distributing computer viruses, and fraud. Consequently, according to a survey by the Federal Bureau of Investigation (FBI), the amount of fraud damage caused by spam emails in 2022 is estimated to reach $2.7 billion (see, for example, Internet Crime Complaint Center, 2020 Internet Crime Report, pp. 3, 2021).

In light of the above background, the techniques about measures against spam mails include Patent Literature (hereinafter also referred to as “PL”) 1 and Non-Patent Literature (hereinafter also referred to as “NPL”) 1. The techniques described in PL 1 and NPL 1 include a mail sending unit that sends electronic data to other computers, and a remittance control unit that generates a remittance transaction for accessing a digital currency blockchain and broadcasts it to the blockchain, wherein as the mail sending unit sends the electronic data, the remittance control unit generates the digital currency remittance transaction on the electronic data and broadcasts it to the blockchain.

### CITATION LIST

### Patent Literature

PL 1: Japanese Patent No. 6583841

### Non-Patent Literature

NPL 1: K. Nakayama, Yutaka Moriyama, C. Oshima, “An Algorithm that Prevents SPAM Attacks using Blockchain,” 2018

### SUMMARY OF INVENTION

### Technical Problem

In the technology described in PL 1, digital currency is paid when electronic data is sent. At this time, if an electronic data receiving side does not properly set sender's sending cost required to receive such electronic data, problems such as not being able to receive legitimate electronic data and receiving illegitimate electronic data such as a spam mail or junk email.

To solve the problems described above, an object of the present invention is to provide an information communication device that can reliably send and receive only legitimate emails by appropriately adjusting the sending cost required to send emails.

### Solution to Problem

An aspect of the present invention provides an information communications device that includes: email sending means for sending an email from a first account to a second account; remittance control means for generating a first remittance transaction for sending a cryptocurrency from the first account to the second account when the email sending means sends the email, and broadcasting the first remittance transaction to a blockchain; email receiving means for receiving an email sent from a third account to the first account; reception control means for accessing, when the email receiving means receives the email, the blockchain to confirm a deposit status of the cryptocurrency from the third account to the first account, and identifying the received email as a legitimate email when a deposit amount confirmed is greater than or equal to a predetermined threshold; refund control means for generating, when the reception control means has identified the received email as the legitimate email, a second remittance transaction for sending, from the first account to the third account, the cryptocurrency in the same amount as a third remittance transaction of the cryptocurrency generated when the received email has been sent from the third account, in response to the third remittance transaction, and broadcasting the second remittance transaction to the blockchain; and threshold control means for adjusting the threshold depending on a type of the received email. The second account may be sane as or different from the third account.

Thus, in the information communications device according to the aspect of the present invention, the following processes are performed: sending an email from a first account to a second account; generating a first remittance transaction for sending a cryptocurrency from the first account to the second account when the email is sent, and broadcasting the first remittance transaction to a blockchain; receiving an email sent from a third account to the first account; accessing, when the email is received, the blockchain to confirm a deposit status of the cryptocurrency from the third account to the first account, and identifying the received email as a legitimate email when a deposit amount confirmed is greater than or equal to a predetermined threshold; generating, when the received email has been identified as the legitimate email, a second remittance transaction for sending, from the first account to the third account, the cryptocurrency in the same amount as a third remittance transaction of the cryptocurrency generated when the received email has been sent, in response to the third remittance transaction, and broadcasting the second remittance transaction to the blockchain; and adjusting the threshold depending on a type of the received email. This enables reception of illegitimate emails to be eliminated without preventing legitimate emails from being sent and received.

### BRIEF DESCRIPTION OF DRAWINGS

FIG. 1 is a system outline overview of a SAGA_{BC} system using an information communication device according to a first embodiment of the present invention;

FIG. 2 is a sequence diagram showing an example of a processing procedure of a mailer in the SAGA_{BC} system;

FIG. 3 is a diagram showing an expected behavior in adjusting a threshold in the information communication device according to the first embodiment of the present invention;

FIG. 4 is a functional block diagram showing the configuration of the information communication device according to the first embodiment of the present invention;

FIG. 5 is a diagram showing an example of information stored in a correspondence information storage unit;

FIG. 6 is a diagram showing the processing of a reception control unit;

FIG. 7 is a flowchart showing the processing performed when sending an email (when sending an MSC) in the information communication device according to the first embodiment of the present invention;

FIG. 8 is a flowchart showing the processing performed when receiving an email in the information communication device according to the first embodiment of the present invention;

FIG. 9 is a flowchart showing a refund process in the information communication device according to the first embodiment of the present invention;

FIG. 10 is a Nassi-Shneiderman (NS) chart showing an experimental model of the information communication device according to the present invention;

FIG. 11 is a diagram showing the number of spam mails received by general users of a conventional SAGA_{B}c system when the utilization ratio of the conventional SAGA_{BC} system is 50%;

FIGS. 12A and 12B are diagrams showing the result of comparing the numbers of spam mails received by general users of the SAGA_{B}c system with the rate of decline in threshold and the magnification of increase in threshold varied in an information communication device of an example;

FIGS. 13A to 13C are diagrams showing average amounts of cryptocurrency possessed by the general users and average thresholds in the information communication device according to the example.

FIG. 14 is a diagram showing the result of calculating and comparing (the number of spam mails received)/(the number of emails that can be sent simultaneously) in the information communication device according to the example.

### DESCRIPTION OF EMBODIMENTS

### First Embodiment of the Present Invention

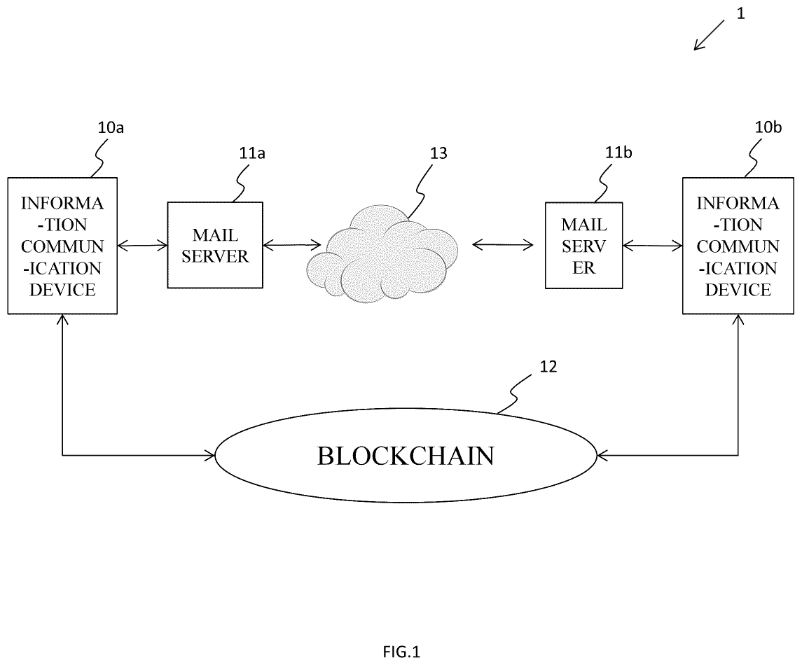

An information communication device according to the present embodiment will be described with reference to FIGS. 1 to 10. The information communication device according to the present embodiment constitutes the SPAM Attack Guard Algorithm using Block Chain (hereinafter referred to as “SAGA_{BC}”) system developed by the inventors. The basic concept and system configuration of the SAGA_{BC} are described in the above-mentioned Patent Literature 1 and Non-Patent Literature 1.

In the SAGA_{BC}, the cost of sending emails is mutually paid with cryptocurrency (digital currency) to prevent spam attacks. Typically, when a legitimate email is sent to a legitimate email address, such an email is legitimately received, so that the number of emails sent matches the number of such emails received. On the other hand, many of the emails sent in large quantities by a spammer to random addresses are not received legitimately. Consequently, the number of emails sent by the spammer does not match the number of such emails received.

The SAGA_{BC} focuses on this difference between the number of emails sent and the number of emails received, and uses a blockchain technique to pay the cost of sending an email in cryptocurrency, which is returned if the email is received legitimately. In other words, a general user who sends an email that will be received legitimately bears almost no cryptocurrency cost of this system, but a user such as a spammer, who sends large quantities of emails that will not be received legitimately, must incur the cost of replenishing his/her cryptocurrency. This can prevent spam attacks by spammers.

Here, the definitions of the terms used in the present embodiment will be indicated below. “Blockchain” is a type of distributed database, where data is sequentially accumulated in units called blocks. Each block records Hash values up to the immediately preceding block. This necessitates, to falsify data in the middle, the calculation of Hash values for all data following a block to be falsified, so that it is difficult to falsify data of the blockchain.

“Cryptocurrency” is a type of digital currency realized by blockchain technology. Commonly known cryptocurrencies include Bitcoin (reference: S. Nakamoto, Bitcoin: A Peer-to-peer Electronic Cash System. 2008) and Ethereum (reference: G. J. Wood, Ethereum: A Secure Decentralised Generalised Transaction Ledger, Ethereum project yellow paper, 151, pp. 1-32, 2014), which have actual monetary value, but there are also many cryptocurrencies that have no value. The blockchain technology enables cryptocurrencies that are difficult to counterfeit and replicate.

“Wallet” is a general term for mechanisms for managing cryptocurrencies. There are various forms, from a web wallet that is stored online, to a cold wallet that is stored on a terminal disconnected from a network. Cryptocurrency users manage cryptocurrencies in their wallets, and remittance and receipt of cryptocurrencies are carried out between the wallets (reference: A. Hayes, What factors give cryptocurrencies their value: An empirical analysis. 2015).

“Wallet account” is an ID used to identify a blockchain wallet. Each user manages his/her cryptocurrency through a unique wallet account. In Bitcoin and Ethereum, this wallet account is created based on a public key used in public key cryptography. Cryptocurrency users manage their remaining cryptocurrency balances on a wallet account basis.

“Transaction” is cryptocurrency transaction data recorded on the blockchain. It is typically data that records a remittance from a certain wallet account to another wallet account. A wallet account that sends cryptocurrency needs to sign a transaction that describes one's own wallet account and a destination wallet account with one's own private key and send it to issue the transaction.

“Mining” is a process of combining a plurality of issued transactions into one block that can be recorded on the blockchain and recording it at the head of the blockchain (reference: M. Omri, “A conceptual framework for the regulation of cryptocurrencies,” U. Chi. L. Rev. Dialogue, Vol. 82, pp. 53-68, 2015). The recordation on the blockchain causes transaction history to be confirmed in an unfalsifiable manner. It takes a few minutes from issuance to confirmation of a transaction.

Next, the configuration of the SAGA_{BC} system will be described. FIG. 1 is a system outline overview of the SAGA_{BC} system using the information communication device according to the present embodiment. The SAGA_{BC} system 1 includes information communication devices 10 (10a, 10b) used by users to send and receive emails via the Internet 13, mail servers 11 (an email sending server 11a and an email receiving server 11b) that manage sending and receiving of emails used by the respective users, and a blockchain 12 for cryptocurrency to be exchanged between the respective users of the information communication devices 10a and 10b.

For example, when an email is sent from an email address set in one email account used by one user as a sender to an email address set in another email account used by another user as a recipient, that is, when an email is sent from the information communication device 10a to the information communication device 10b as shown in FIG. 1, an outgoing email created by the information communication device 10a is sent to the information communication device 10b via the email sending server 11a for the sender and the email receiving server 11b for the recipient. This series of email transmission/reception is performed by a common method, for example, via an SMTP server or a POP3 server. The information communication device 10a generates a remittance transaction for cryptocurrency at the same time as sending the email, and broadcast it to the blockchain 12. The remittance transaction generated at this time indicates remittance of a predetermined amount of cryptocurrency from the wallet of the sender, who is the user of the information communication device 10a, to the wallet of the recipient, who is the user of the information communication device 10b.

The information communication device 10b receives (temporarily receives at this stage) the email and accesses the blockchain 12 to check a deposit status of the email, such as whether the cryptocurrency has been deposited in the recipient's own wallet or whether the deposit amount is greater than or equal to a predetermined amount. The email is received as a legitimate email and displayed in the inbox only when the deposit status is appropriate, such as when the deposit has been confirmed or when the deposit whose amount is greater than or equal to the predetermined amount has been confirmed. In addition, when the deposit status is inappropriate, such as when the deposit has not been confirmed or when the deposit amount has been less than the predetermined amount, the email may be unconditionally discarded or moved to the trash, or may be displayed in the inbox once and then displayed in a manner that the recipient can understand that the email has not been accompanied by any deposit of cryptocurrency (such as, for example, alert display, highlighting, display in different colors).

In the above, for the sake of clarity, one-way information communication has been described in which the information communication device 10a, where one user is assumed as the sender and one account (one email account and one wallet account) used by such one user is set, sends an email and cryptocurrency to the information communication device 10b, where another user is assumed as the recipient and another account (another email account and another wallet account) used by such another user is set, and the information communication device 10b used by the other user receives the email and checks the deposit of the cryptocurrency. In fact, both of the information communication device 10a used by the one user and the information communication device 10b used by the other user have the function of sending and receiving emails mutually in both directions, as well as the function of sending cryptocurrency and confirming deposit thereof.

The SAGA_{BC} system 1 shown in FIG. 1 associates email accounts for sending and receiving emails with wallet accounts for accessing the blockchain 12. In the SAGA_{BC} system 1, a wallet account is assigned for each email account held by an email client. That is, the email client associates a cryptocurrency wallet account with an email address set in the email account.

A unique cryptocurrency called Mail Send Coin (MSC) is created and used as the cryptocurrency implemented in the SAGA_{BC} system 1. This MSC is not intended to have monetary value, but is a cryptocurrency to be given at the time of sending an email (i.e., to be remitted along with the sending of an email, or to be refunded along with the receiving of a legitimate email). In addition, existing cryptocurrencies such as Bitcoin and Ethereum may be used as the MSC.

The main functions of the SAGA_{BC} system 1 are implemented in mailers installed in the information communication devices 10a and 10b. A typical mailer is a software for sending and receiving emails, and manages sending and receiving from one or more email addresses. In the SAGA_{BC} system 1, the functions required for the SAGA_{BC} system 1 are implemented as extended functions in the typical mailer. The main contents of the extended functions will be specifically described below.

### (1) Account Management Function

This function manages a wallet account corresponding to a users' email account.

### (2) Account Registration Function

This function associates a hash value of an email address with a wallet account and registers them in a blockchain.

### (3) Account Confirmation Function

This function confirms a wallet account corresponding to a destination email address at the time of sending an email.

### (4) Incoming Email and Deposited MSC Correspondence Function

This function matches a received email with a deposited MSC, and saves this data.

### (5) Junk Email Sorting Function

This function displays an email, sorts it into a junk email folder, or deleting it, depending on the deposit amount of MSC corresponding to a respective email received.

### (6) Remittance Function

This function sends MSC from a wallet account corresponding to his/her own email account, and determines an amount of remittance (hereinafter referred to as “sending MSC amount”).

### (7) Mining Function

This function replenishes MSC when there is a shortage of MSC to be sent with the sending of emails, by mining MSC transactions issued by many users. A spammer can also use this function to replenish his/her MSC, but this comes at a high calculation cost.

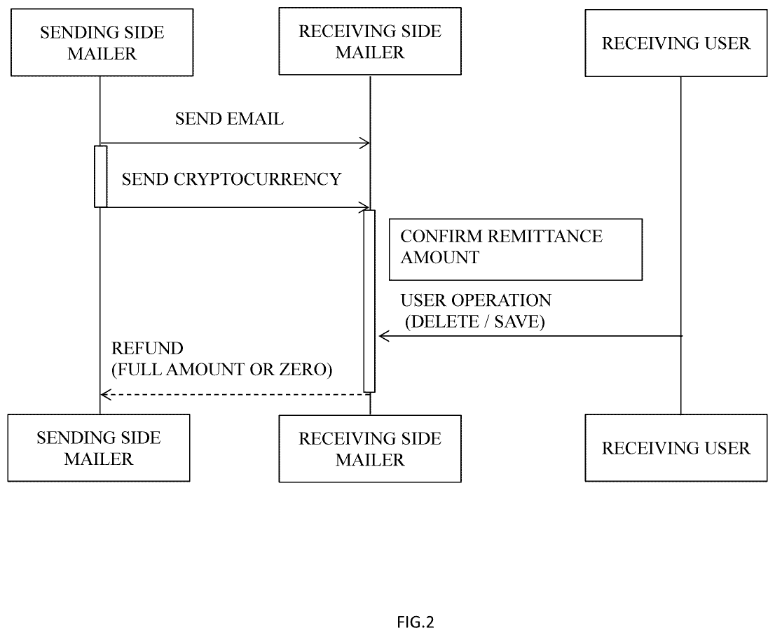

A processing procedure of the above-mentioned mailer will be described. FIG. 2 is a sequence diagram showing an example of the processing procedure of the mailer in the SAGA_{BC} system. In FIG. 2, a sending side mailer issues, when sending an email, a remittance transaction of the sending MSC amount from its own wallet account to the wallet account corresponding to the destination email address. A receiving side mailer, when receiving the email, sorts it as an illegitimate email (for example, a spam mail or junk email) if the sending MSC amount remitted from the email sender is less than a receiving MSC threshold set by the receiving side mailer. If the sending MSC amount is greater than or equal to the receiving MSC threshold, the receiving side mailer determines the received email to be a legitimate email (for example, an email to be confirmed/displayed/saved/replied, etc.), and returns the MSC directly to the sender's wallet account, depending on the user's operation (for example, delete/save/reply, etc.) on this email. For example, when the email received as the legitimate email has been deleted or moved to a junk email folder, the refund amount is set to zero (0). When the email has been opened and then not deleted nor moved to the junk email folder for a certain period of time, the same amount as the sending MSC amount is returned to the sender's wallet account.

Note that the sequence diagram illustrated in FIG. 2 shows the processing when both of the sending side and the receiving side have installed the SAGA_{BC} system 1. When only the sending side has installed the SAGA_{BC} system 1, for example, the account confirmation function described in the above (3) can be used to confirm that the receiving side (destination) has not installed the SAGA_{BC} system 1 (i.e., the wallet account associated with the destination email address has not been registered). Thus, in such a case, a normal processing of only sending an email without generating an MSC remittance transaction may be performed.

Further, when only the receiving side has installed the SAGA_{BC} system 1, for example, the incoming email and deposited MSC correspondence function described in the above (4) can be used to confirm that the MSC corresponding to the received email has not been deposited. Further, the account management function described in the above (1) can be used to confirm that the email account from which the email has been sent does not use the SAGA_{BC} system 1 (i.e., the wallet account associated with the source email address has not been registered). Thus, in such a case, the email may be treated as a normal received email that cannot be confirmed not to be an illegitimate email.

Furthermore, when neither the sending side nor the receiving side has installed the SAGA_{BC} system 1, for example, only sending and receiving a normal email that cannot be confirmed not to be an illegitimate email will take place.

In the above SAGA_{BC} system 1, the cost of sending emails is mutually paid by MSC. The important values to be adjusted here are the sending MSC amount to be transferred when sending an email and the receiving MSC threshold that is a reference value of the MSC amount required to receive the email as a legitimate email. If these values are inappropriate, problems such as legitimate emails not being delivered and illegitimate emails being delivered may occur, so that it is necessary to introduce an algorithm to adjust these values. The present embodiment focuses on only the receiving MSC threshold out of the sending MSC amount and the receiving MSC threshold. This is because the sending side mailer can check the receiving MSC threshold before remittance as described below, and thus there is no merit in sending a cryptocurrency that exceeds such a threshold.

In the information communication device 10 according to the present embodiment, the receiving MSC threshold is adjusted by the algorithm shown in the following Formula (1). This algorithm is such that a congestion control algorithm for avoiding and reducing congestion in TCP is applied to the SAGA_{BC} system 1, and is particularly based on the additive-increase/multiplicative-decrease (AIMD) (Y. R. Yang, S. S. Lam, General AIMD congestion control, 2000) control in the loss-based congestion control (Dah-Ming Chiu, Raj Jain, Analysis of the increase and decrease algorithms for congestion avoidance in computer networks, 1989). This is a control method in which the congestion window size is additively increased until packet loss occurs, and the congestion window size is multiplicatively decreased when packet loss has occurred.

$$( Formula 1 )$$

$${b}_{d} ( t - 1 ) = \{ \begin{matrix}{b}_{d} ( t ) - x ( Upon non - receipt of spam mail ) \\ {b}_{d} ( t ) ⋆ y ( Upon receipt of spam mail )\end{matrix} ( x , y > 0 )$$

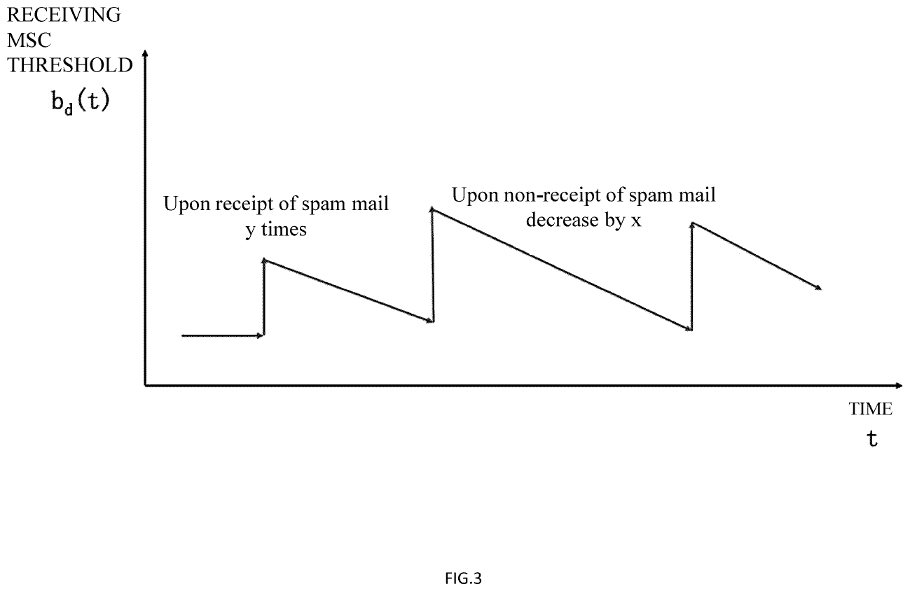

As shown in Formula (1), the receiving MSC threshold is additively decreased until an illegitimate email such as a spam mail is received, and when the spam mail is received, the receiving MSC threshold is multiplicatively increased. That is, for a receiving MSC threshold b_{d}(t) at time t, the receiving MSC threshold b_{d}(t+1) updated at time t+1 will have the value as shown in Formula (1). When the receiving MSC threshold is adjusted according to the algorithm of Formula (1), the behavior is as shown in FIG. 3. This adjustment of the receiving MSC threshold also causes the sending MSC amount (MSC amount remitted when sending an email) to change accordingly.

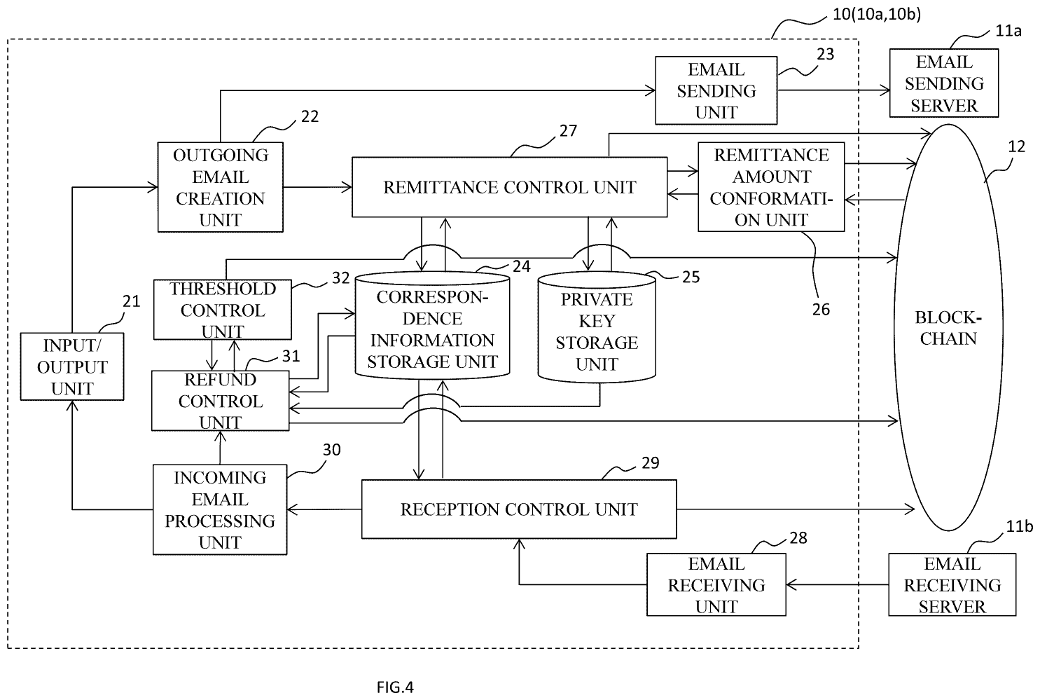

FIG. 4 is a functional block diagram showing a configuration of the information communication device according to the present embodiment. First, processing when sending an email will be described. In FIG. 4, the information communication device 10 includes: an input/output unit 21 that performs input/output of information in response to an operation of a sender of an email; an outgoing email creation unit 22 that creates an email for sending in response to the inputted operation; an email sending unit 23 that sends the created email for sending to the email sending server 11a; a correspondence information storage unit 24 that stores both email addresses of a sender and a recipient (i.e., a source email address of the sender and a destination email address of the recipient) in association with their wallet accounts; a private key storage unit 25 that stores a private key required as a signature when accessing the blockchain 12; a remittance amount conformation unit 26 that acquires a receiving MSC threshold for receiving an outgoing email as a legitimate email, set in a wallet account on the side of a recipient of such an outgoing email, and compares the MSC amount owned by a sending side wallet account with the obtained receiving MSC threshold to determine whether remittance of MSC is enabled; and a remittance control unit 27 that reads out the wallet accounts of the sender and recipient stored in the correspondence information storage unit 24, from the source email address of the sender of the outgoing email and the destination email address of the recipient of the outgoing email, generates a remittance transaction for remitting a sending MSC amount equal to (or may be greater than) the receiving MSC threshold from the sender's wallet to the recipient's wallet, and signs the generated remittance transaction using the private key information stored in the private key storage unit 25 to broadcast it to the blockchain 12. These components function in the processing when sending an email.

Here, the processing of the remittance amount confirmation unit 26 and the remittance control unit 27 will be described in more detail. The remittance amount confirmation unit 26 makes an inquiry to the blockchain 12 to confirm the receiving MSC threshold set in the wallet account corresponding to the destination email address of the recipient when an email is sent, and acquires the receiving MSC threshold. The receiving MSC threshold is a threshold set on the recipient side as described above, and a value based on which the received email is sorted as an illegitimate email (such as a junk email and spam mail) if the sending MSC amount remitted from the sender side is less than the receiving MSC threshold, or it is determined to be a legitimate email if the sending MSC amount remitted from the sender side is greater than or equal to the receiving MSC threshold. The remittance amount confirmation unit 26 compares the acquired receiving MSC threshold with the amount of MSC held in the sender's wallet, and if the amount of MSC held in the sender's wallet is less than the receiving MSC threshold, it passes information indicating that the MSC cannot be remitted, to the remittance control unit 27. If the amount of MSC held in the sender's wallet is greater than or equal to the receiving MSC threshold, the remittance amount confirmation unit 26 passes information on the acquired receiving MSC threshold to the remittance control unit 27.

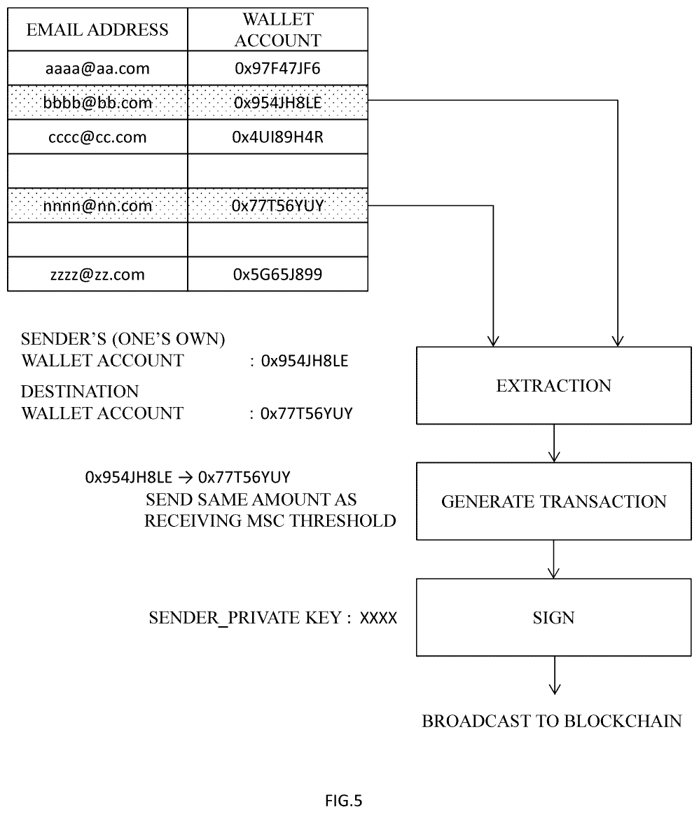

The remittance control unit 27 performs a remittance process of the MSC from the sender's wallet to the recipient's wallet according to the information received from the remittance amount confirmation unit 26. FIG. 5 is a diagram showing an example of information stored in the correspondence information storage unit 24. In the correspondence information storage unit 24, email addresses, which are identification information for identifying each of senders and recipients of emails, and wallet accounts, which are identification information required for accessing the blockchain 12, are stored in a one-to-one correspondence. The remittance control unit 27 does not perform the remittance process when it has received the information indicating that the MSC cannot be remitted, from the remittance amount confirmation unit 26. The remittance control unit 27 performs a remittance process of the amount equal to the receiving MSC threshold when it has received the information on the receiving MSC threshold, from the remittance amount confirmation unit 26. Specifically, the remittance control unit 27 extracts a wallet account that corresponds to an email address of the sender himself/herself who sends an outgoing email created by the outgoing email creation unit 22. Additionally, the remittance control unit 27 extracts a wallet account that corresponds to an email address of the destination who is the recipient of the outgoing email. Using these wallet accounts, the remittance control unit 27 identifies the remittance source wallet account and the remittance destination wallet account, and generates a remittance transaction that records the remittance amount equal to the receiving MSC threshold.

And then, when the remittance transaction has been generated, the remittance control unit 27 signs it with the private key information stored in the private key storage unit 25, thereby making it possible to broadcast the generated remittance transaction to the blockchain 12 to write remittance information (remittance history) to the blockchain 12. Since it is extremely difficult to falsify the blockchain 12, the remittance information written here will be highly reliable and can function as value of the sent email.

Next, processing when receiving an email will be described. In FIG. 4, the information communication device 10 includes: an email receiving unit 28 that receives an email sent to the recipient himself/herself from the email receiving server 11b; a reception control unit 29 that reads out a wallet account corresponding to the source email address of the sender from the correspondence information storage unit 24, from the email received by the email receiving unit 28, and queries the blockchain 12 to confirm whether or not the sender has remitted an MSC and/or the remittance amount; and an incoming email processing unit 30 that displays the received email as a legitimate email when the sender has remitted the MSC or when the remittance amount is greater than or equal to the received MSC threshold, and otherwise performs a process such as discarding the received email as an illegitimate email. These components function in the processing when receiving an email.

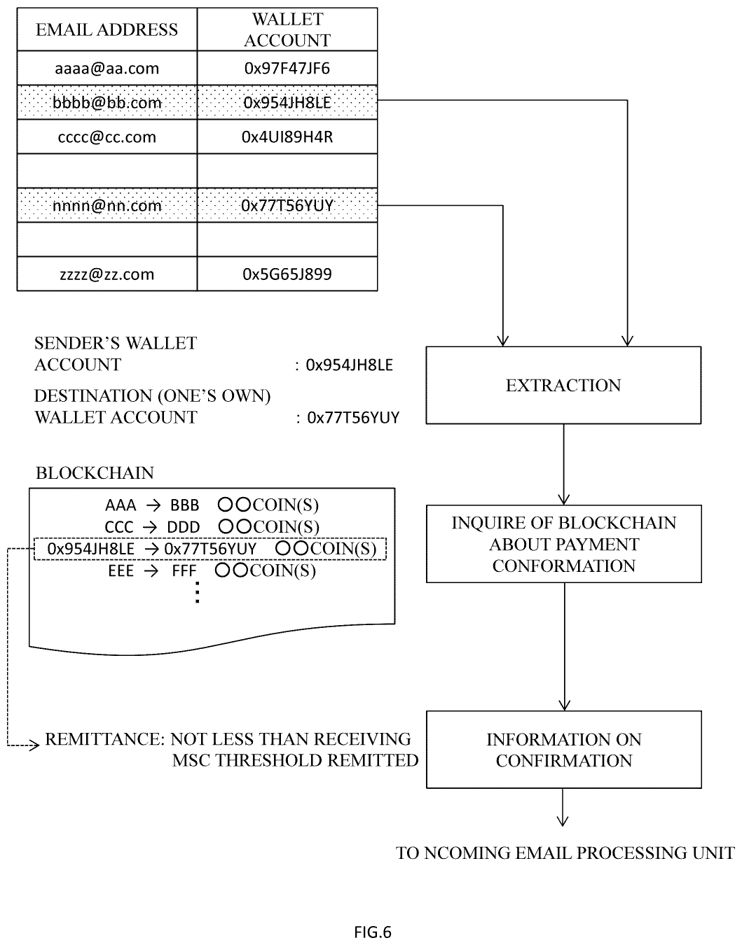

Each processing unit will be described in more detail. FIG. 6 is a diagram showing the processing of the reception control unit 29. As shown in FIG. 6, the reception control unit 29 extracts a wallet account that corresponds to the source email account of the sender of the email received by the email receiving unit 28. At the same time, the reception control unit 29 extracts a wallet account that corresponds to the recipient's own email address which is the destination of the email. From these extracted wallet accounts, the reception control unit 29 make an inquiry to the blockchain 12 to confirm the deposit status of the MSC from the sender's wallet account to the recipient's own wallet account. Then, the reception control unit 29 passes information on the confirmed deposit status to the incoming email processing unit 30 together with information on the received email.

The incoming email processing unit 30 that has received the information on the email and the information on the deposit status, performs predefined processing (such as, for example, displaying the email in an inbox normally, displaying the email in an inbox together with information on the presence or absence of a deposit or the amount of the deposit, discarding the email in a trash, discarding the email completely, and processing the email as a junk email) according to the deposit status (whether or not there is a deposit, or whether or not there is a deposit of a predetermined amount or more). Note that the processing of the incoming mail processing unit 30 may be defined according to the amount of MSC deposited. For example, the email may be sorted into different folders according to the deposit amount, or the email may be highlighted when the deposit amount has been greater than a predetermined amount, and displayed normally when the deposit amount has been less than the predetermined amount. This enables a sender to send a larger amount of MSC to encourage a recipient to confirm an email as a priority in a case such as an emergency.

Next, refund processing when an email has been received will be described. In FIG. 4, the information communication device 10 includes: a refund control unit 31 that generates a remittance transaction for remitting MSC from the destination wallet account of the recipient to the source wallet account of the sender, and signs the generated remittance transaction using the private key information stored in the private key storage unit 25 to broadcast it to the blockchain 12, in order to refund the MSC deposited when the email has been received, according to a content of processing performed by the incoming email processing unit 30 for the incoming email and a content of an operation performed by the recipient at the input/output unit 21; and a threshold control unit 32 that calculates the receiving MSC threshold based on the algorithm of the above-mentioned formula (1), and broadcasts it to the blockchain 12 for updating.

The refund control unit 31 performs the processing of refunding the MSC deposited when the email has been received, according to the content of the processing performed by the incoming email processing unit 30 for the incoming email and the content of the operation performed by the recipient at the input/output unit 21. Specifically, for example, when the received email is determined to be a spam mail (illegitimate email) by standard functions of an email server or mailer and is discarded by the incoming email processing unit 30, no refund is performed. Further, when the email is received as a legitimate email and displayed in the inbox, but the recipient does not operate the input/output unit 21 and refer to the content, or refers to the content but ultimately discards the received email, no MSC is refunded. When the recipient ultimately refers to the content of the received email and saves it, or creates a reply email to the received email for sending, all the MSC that has been deposited upon reception of the email is refunded.

The refund process by the refund control unit 31 is similar to the remittance process performed when an email is sent. The refund control unit 31 accesses the correspondence information storage unit 24 and extracts a wallet account corresponding to the source email address of the sender of the received email. Then, the refund control unit 31 generates a remittance transaction (hereinafter referred to as a “refund transaction”) of the refund amount determined as described above from the recipient's own wallet account whose corresponding email address is the destination of the email to the extracted sender's wallet account, and signs it with the private key information stored in the private key storage unit 25. The generated refund transaction is broadcast to the blockchain 12 for refunding. Note that when a refund process occurs, the sender may be notified of that effect.

The threshold control unit 32 calculates the receiving MSC threshold at the timing when the refund control unit 31 determines whether to perform the refund process. Specifically, the receiving MSC threshold is calculated according to the above formula (1). When the refund process is performed, that is, when a legitimate email to be, for example, displayed or confirmed has been received, the receiving MSC threshold is decreased by subtracting a predetermined value therefrom. On the other hand, when the refund process is not performed, that is, when an illegitimate email the reception of which is not even displayed in an inbox is received, or when an email the reception of which is carried out but the content of which is not displayed/confirmed is received, the receiving MSC threshold is increased by multiplying it by a predetermined value. Information on the calculated receiving MSC threshold is broadcast to the blockchain 12 by the threshold control unit 32 and managed on the blockchain 12.

Adjusting the receiving MSC threshold causes the receiving MSC threshold set on the recipient side to rise exponentially as more spam mails are sent, thus increasing the sending cost for a spammer, and consequently enabling reduction of spam mails. On the other hand, for non-spammers who use normal emails, MSC values held by them do not fluctuate significantly, and the receiving MSC threshold gradually decreases, thus allowing them to send and receive emails stably.

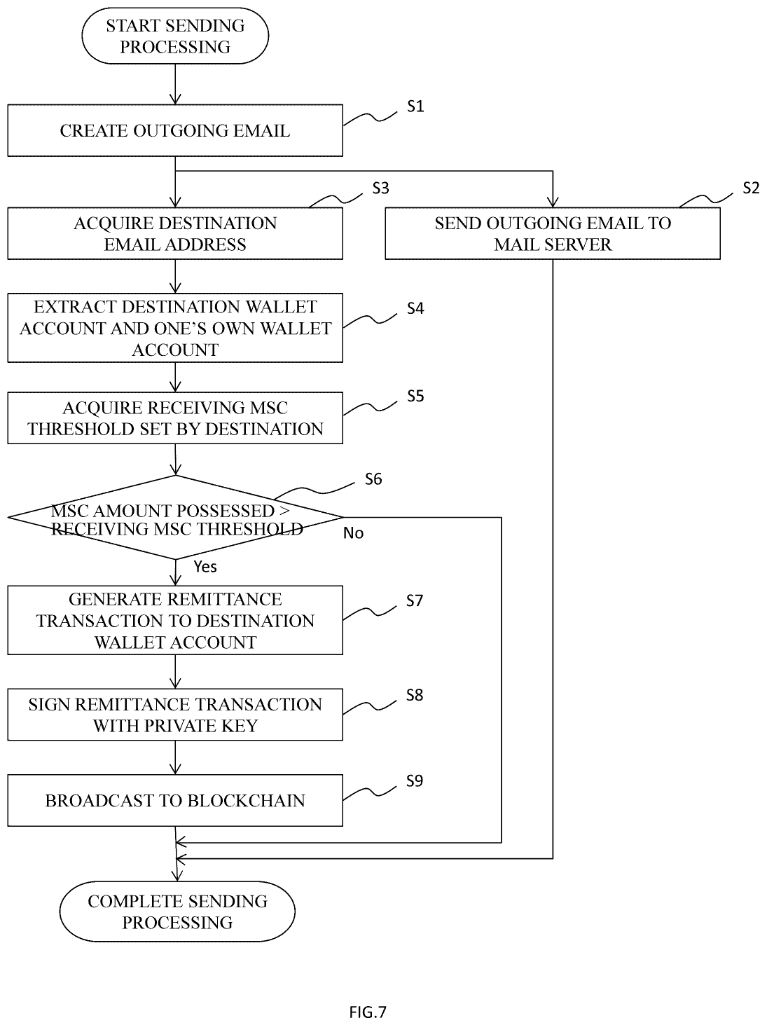

Next, an operation of the information communication device according to the present embodiment will be described. FIG. 7 is a flowchart showing the processing performed when sending an email (when remitting an MSC) in the information communication device according to the present embodiment. In FIG. 7, first, the outgoing email creation unit 22 creates an outgoing email in response to an operation of the input/output unit 21 performed by a sender (S1). The email sending unit 23 sends the created outgoing email to the email sending server 11a (S2). At the same time when the outgoing email is passed to the email sending unit 23 in S2, the remittance control unit 27 receives a destination of a recipient of the outgoing email (S3). The remittance control unit 27 accesses the correspondence information storage unit 24, and extracts wallet accounts respectively corresponding to a destination email address of the recipient and a source email address of the sender himself/herself (S4). The remittance amount confirmation unit 26 queries the blockchain 12 to acquire a receiving MSC threshold set on the recipient side (S5), and compares the MSC amount held by the sender's wallet account with the receiving MSC threshold (S6). When the MSC amount held is less than the receiving MSC threshold, the sending process ends with the MSC unremitted. When the MSC amount held is greater than or equal to the receiving MSC threshold, information on the receiving MSC threshold acquired is passed to the remittance control unit 27.

When the remittance control unit 27 receives the information on the receiving MSC threshold, it generates a remittance transaction for remitting the MSC from the source wallet account of the sender himself/herself to the destination wallet account of the recipient (S7). Then, the remittance control unit 27 reads out private key information from the private key storage unit 25 and signs the generated remittance transaction (S8). Then, the generated remittance transaction is broadcast to the blockchain 12 (S9), completing the processing of sending an email.

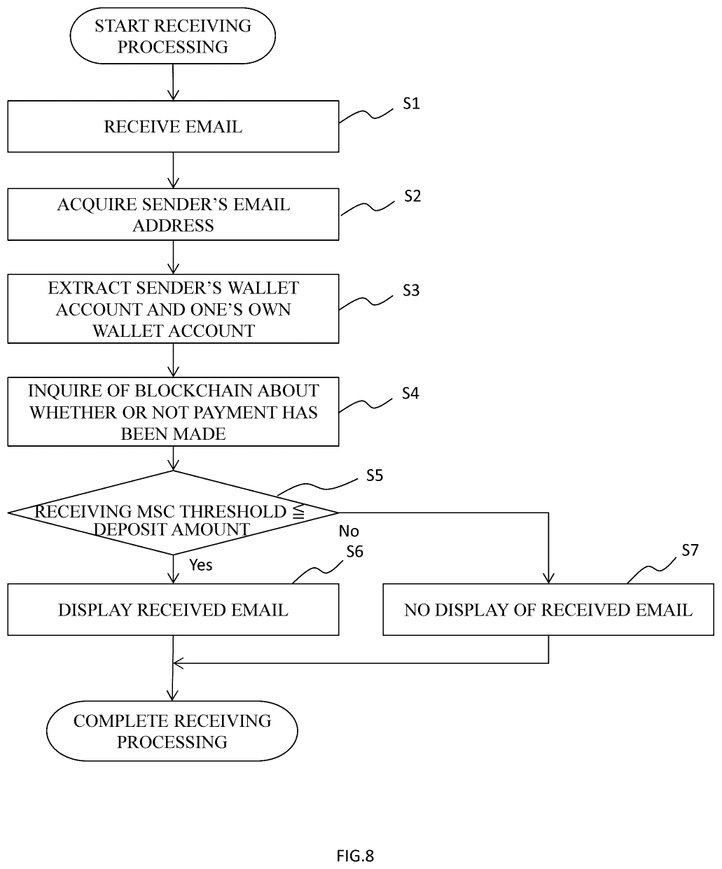

FIG. 8 is a flowchart showing the processing performed when receiving an email in the information communication device according to the present embodiment. In FIG. 8, first, the email receiving unit 28 receives an email from the email receiving server 11b (S1). The reception control unit 29 receives an email address of a sender of the email received (S2). Then, the reception control unit 29 accesses the correspondence information storage unit 24 and extracts wallet accounts respectively corresponding to a source email address of the sender and a destination email address of a recipient himself/herself (S3). Then, the reception control unit 29 queries the blockchain 12 about the deposit status of the MSC from the source wallet account of the sender to the destination wallet account of the recipient himself/herself (S4). Then, the reception control unit 29 confirms whether the deposit amount of the MSC is greater than or equal to a receiving MSC threshold set by the reception control unit 29 itself (S5), and passes the confirmation result to the incoming email processing unit 30. The incoming email processing unit 30 performs a process to regard the received email as a legitimate email and display this received email when it has received a confirmation result that the deposit amount of the MSC deposited is greater than or equal to the receiving MSC threshold (S6). The incoming email processing unit 30 performs a process to regard the received email as an illegitimate email and not to display this received email when it has received a conformation result that the deposit amount of the MSC deposited is less than the receiving MSC threshold (S7), completing the processing of receiving an email.

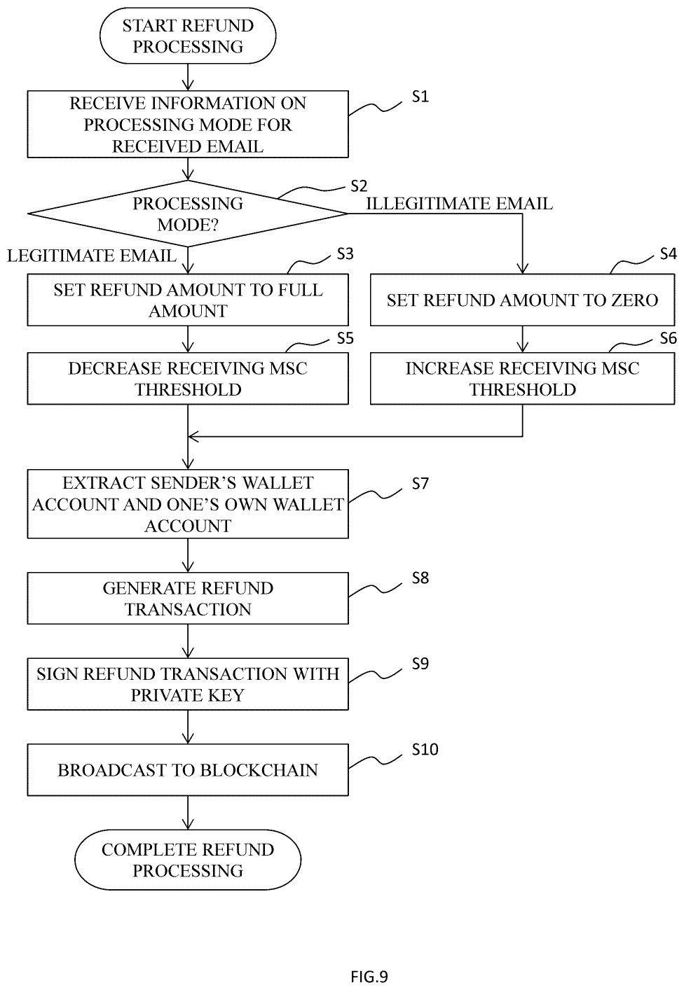

FIG. 9 is a flowchart showing a refund process in the information communication device according to the present embodiment. In FIG. 9, first, the refund control unit 31 receives a processing mode of the incoming mail processing unit 30 or a processing mode of the input/output unit 21 in the processing performed when an email is received (S1). The refund control unit 31 determines whether the received processing mode is a processing mode when a legitimate email is received (S2). The refund control unit 31 sets a refund amount to an amount equal to the MSC deposited when the email has been received, when the refund control unit 31 has confirmed in S2 that the received processing mode is the processing mode when a legitimate email is received (S3). On the other hand, the refund control unit 31 sets the refund amount to zero (0), when the refund control unit 31 has confirmed in S2 that the received processing mode is not the processing mode when a legitimate email is received (S4). Further, the threshold control unit 32 decreases the receiving MSC threshold by subtracting a predetermined value therefrom, when the refund control unit 31 has confirmed in S2 that the received processing mode is the processing mode when a legitimate email is received (S5). On the other hand, the threshold control unit 32 increases the receiving MSC threshold by multiplying it by a predetermined value, when the refund control unit 31 has confirmed in S2 that the received processing mode is not the processing mode when a legitimate email is received (S6).

The refund control unit 31 accesses the correspondence information storage unit 24 and extracts wallet accounts respectively corresponding to a source email addresses of the sender and a destination email address of a recipient himself/herself (S7). Then, the refund control unit 31 generates a refund transaction for remitting the MSC from the destination wallet account of the recipient himself/herself of the received email to the source wallet account of the sender (S8). Then, the refund control unit 31 reads out the private key information from the private key storage unit 25 and signs the generated refund transaction (S9). Then, the refund control unit 31 broadcasts the generated refund transaction to the blockchain 12, and the threshold control unit 32 broadcasts information for updating the information on the receiving MSC threshold, calculated in S5 and S6, to the blockchain 12 (S10), completing the refund process and the updating of the receiving MSC threshold.

Note that the above-mentioned receiving MSC threshold may be set to different values for different sender's email accounts. For example, a lower deposit amount may be sufficient for the deposit amount from a wallet account corresponding to an email account of such a sender who is registered in an address book, has a history of sending and receiving emails in the past, or usually sends and receives emails, while a higher deposit amount may be desired for the deposit amount from a wallet account corresponding to an email account of a sender other than the above such as from whom an email is received for the first time. Setting the receiving MSC threshold for each email account or for each type of email account (for example, a type indicating whether or not there is a history of sending and receiving emails) causes a spammer (i.e., a sender who sends spam mails) to be required to pay a large cost, consequently enabling reduction of illegitimate emails such as spam mails.

Further, the respective functions as mentioned above may be realized as the information communication device 10 by installing a mailer (including an extended function of the mailer) on a user's computer, or may be realized by implementing a processing unit that performs processing other than sending and receiving emails (all processing related to MSC) in FIG. 4 in the email sending server 11a and/or the email receiving server 11b. Further, a so-called smart contract that performs remittance and refund processing on a blockchain may be used to have a configuration in which the correspondence information storage unit 24 is provided on the blockchain 12, and a contract performance unit that carries out contract processing related to the transfer of MSC on the blockchain 12 is provided.

Further, the email sending processing of FIG. 7 indicates the processing mode in which an email can be sent with the MSC unremitted. The processing mode in the email sending processing of FIG. 7 is not limited to this mode. The processing mode may be such that an email cannot sent with the MSC unremitted. Specifically, the processing up to S6 may be performed before an outgoing mail is sent to the email sending server 11a in S2, and based on a result of this processing, the outgoing mail may be sent or unable to be sent.

Furthermore, the refund processing of FIG. 9 indicates the processing mode in which the threshold control unit 32 broadcasts the receiving MSC threshold calculated by this threshold control unit 32 to the blockchain 12. The processing mode in the refund processing of FIG. 9 is not limited to this mode. The processing mode may be such that the threshold control unit 32 passes the information on the receiving MSC threshold calculated by this threshold control unit 32 to the refund control unit 31, and the refund control unit 31 broadcasts the information on the receiving MSC threshold to the blockchain 12 along with the refund transaction.

Furthermore, in the above embodiment, one wallet account is associated with one email account. Association of a wallet account with an email account is not limited to this one-to-one correspondence. One wallet account may be associated with multiple-email accounts, or multiple wallet accounts may be associated with one email account.

Furthermore, in the above embodiment, the receiving MSC threshold is managed on the blockchain 12. A location to manage the receiving MSC threshold is not limited to this configuration. The information on the receiving MSC threshold may be managed by individual users in their respective information communication devices 10 that they use. Specifically, for example, in addition to the correspondence information between the email addresses and the wallet accounts of senders and recipients stored in the correspondence information storage unit 24 (hereinafter simply referred to as “correspondence information”), the receiving MSC threshold(s) may be further stored in the correspondence information storage unit 24 in a given correspondence. In this case, when the receiving MSC threshold is set uniformly, the same receiving MSC threshold may be associated with all the correspondence information, and when it is desired to set the receiving MSC threshold individually for each sender, different receiving MSC thresholds of different values may be associated with different correspondence information. In this case, the remittance amount confirmation unit 26 does not query the blockchain 12 as shown in FIG. 4, but queries the mailer on the recipient side via the email sending server 11a, in S5 of FIG. 7, when an email is sent. In response to this query from the sender side, the mailer on the recipient side returns the information on the receiving MSC threshold stored in the correspondence information storage unit 24, and thereby the sender side can know the sending MSC amount required when sending an email. Further, regarding update of the receiving MSC threshold, the value of the receiving MSC threshold stored in the correspondence information storage unit 24 is updated in S10 of FIG. 9, instead of broadcasting the information for updating the information on the receiving MSC threshold calculated by the threshold control unit 32 of FIG. 4 in S5 and S6 of FIG. 9, to the blockchain 12.

As seen from the above, the information communication device according to the present embodiment includes: an email sending unit 23 that sends an email from one account (e.g., one email account) to another account (e.g., another email account); a remittance control unit 27 that generates a remittance transaction for sending an MSC from the one account (e.g., one wallet account) to the another account (e.g., another wallet account) when the email sending unit 23 sends the email, and broadcasts it to the blockchain 12; an email receiving unit 28 that receives an email sent from another account (e.g., another email account) to the one account (e.g., the one email account); a reception control unit 29 that accesses, when the email receiving unit 28 receives the email, the blockchain 12 to confirm a deposit status of the MSC from the another account (e.g., the another wallet account) to the one account (e.g., the one wallet account), and identifies the received email as a legitimate email when a deposit amount confirmed is greater than or equal to a predetermined receiving MSC threshold; a refund control unit 32 that generates, when the reception control unit 29 has identified the received email as the legitimate email, a remittance transaction for sending, from the one account (e.g., the one wallet account) to the another account (e.g., the another wallet account), the MSC in the same amount as a remittance transaction of the MSC generated when the received email has been sent, in response to such a remittance transaction, and broadcasts it to the blockchain 12; and a threshold control unit 32 that adjusts the receiving MSC threshold depending on a type of the received email.

Thus, a sender simultaneously sends an MSC when sending an email to a recipient, and the MSC is returned directly to the sender if the email is a legitimate email for the recipient. This prevents the MSC from being increased or decreased as long as normal emails are sent and received. On the other hand, when an illegitimate email is sent, this email is not received as the legitimate email, and thus the sender's MSC will decrease. That is, normal email exchanges do not incur any cost, but a sender such as a spammer requires a large MSC cost, consequently enabling illegitimate emails such as spam mails to be reduced. At this time, the sending MSC amount required when sending an email is important. In the information communication device 10 according to the present embodiment, this sending MSC amount can be adjusted by the receiving MSC threshold, so that by keeping the sending MSC amount appropriate, it is possible to eliminate reception of illegitimate emails without preventing legitimate emails from being sent and received.

Further, in the information communication device according to the present embodiment, the threshold control unit 32 adjusts the receiving MSC threshold to be smaller when the type of received email is a legitimate email, and adjusts the receiving MSC threshold to be larger when the type of received email is an illegitimate email. This enables the sending MSC amount to be appropriately adjusted using the receiving MSC threshold, eliminating reception of illegitimate emails without preventing legitimate emails from being sent and received.

Further, the threshold control unit 32 identifies the type of the received email in accordance with a type of operation of a recipient who has received the email, so that it is possible to accurately determine whether the received email is legitimate or illegitimate in accordance with the type of operation of the recipient.

Furthermore, the threshold control unit 32 adjusts the receiving MSC threshold to be smaller when the type of operation of the recipient belong to the first operation type including referring to, saving, and/or replying to the received email, and adjusts the receiving MSC threshold to be larger when the type of operation of the recipient belong to the second operation type including discarding the email and/or identifying the email as an illegitimate email. This makes it possible to accurately determine whether the received email is legitimate or illegitimate in accordance with the type of operation of the recipient, while appropriately adjusting the sending MSC amount with the receiving MSC threshold, thus eliminating reception of illegitimate emails without preventing legitimate emails from being sent and received.

Furthermore, the threshold control unit 32 adjusts the receiving MSC threshold to be smaller by subtracting the receiving MSC threshold when the type of the email is a legitimate email, and adjusts the receiving MSC threshold to be larger by multiplying the receiving MSC threshold when the type of the email is an illegitimate email, so that it is possible to reduce illegitimate emails by referring to a congestion control algorithm for avoiding or reducing congestion in TCP.

Furthermore, the receiving MSC threshold is set for each email account or email account type of the sender, so that it is possible to set an appropriate receiving MSC threshold in accordance with the history of previous sending and receiving and the relationship between users.

### EXAMPLES

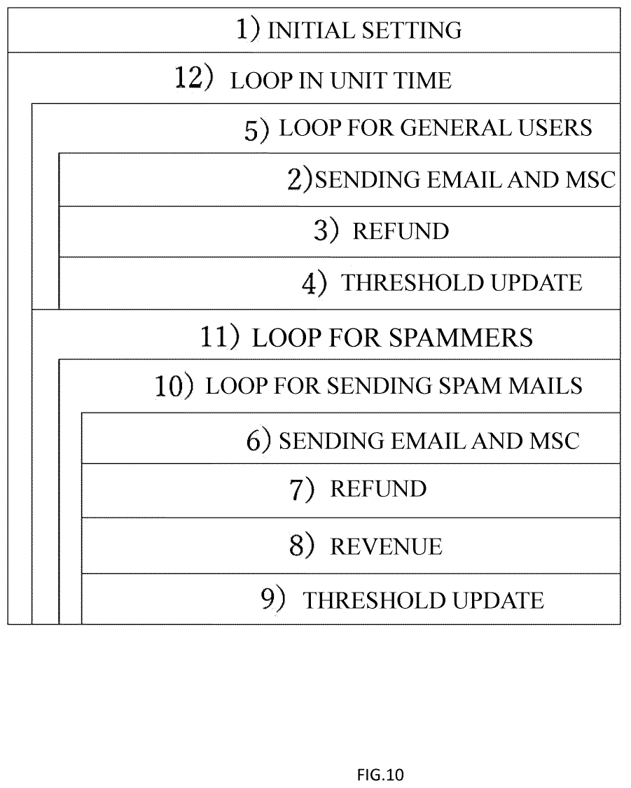

A simulation experiment was conducted using the information communication device 10 according to the present invention in the SAGA_{BC} system. Here, the inventors used the algorithm of the above formula (1) to verify whether spam mails could be reduced when the utilization rate of the SAGA_{BC} system was 50%. FIG. 10 is an NS chart showing an experimental model.

(1) Initial setting: Nu users of SAGA_{BC} system 1 are created in a virtual space, assuming that among them, the number of spammers is Su, and the number of general users is (Nu-Su). Further, Nn non-users of SAGA_{BC} system 1 are created, assuming that among them, the number of spammers is Sn, and the number of general users is (Nn-Sn).

(2) Sending email and MSC: A general user sends one email to an address randomly selected from those of other users excluding the general user himself/herself and the spammers, and simultaneously sends an MSC. At this time, the receiving MSC threshold of the destination is checked, and if the MSC held is greater than or equal to the receiving MSC threshold of the destination, the sending MSC amount is set to the same value as the receiving MSC threshold of the destination. That is, the same amount of MSC as the receiving MSC threshold is sent. If the MSC held is less than the receiving MSC threshold of the destination, no email is sent.

(3) Refund: Assuming that all emails sent by the (Nu-Su) general users are non-spam mails, the same amount of MSC is refunded after the MSC is sent to a wallet account corresponding to an email account of the destination.

(4) Threshold update: A user who has received the email lowers the threshold according to Formula (1).

(5) Loop for general users: Steps (2) to (3) are repeated for the (Nu-Su) general users. Note that the general users are assumed not to perform mining.

(6) Sending email and MSC: A spammer sends an email and an MSC. The spammer randomly selects a destination user from the (Nu-Su) general users who use the SAGA_{BC} system 1 and the (Nn-Sn) general users who do not use the SAGA_{BC} system 1, and sends one spam mail and simultaneously sends an MSC. At this time, the spammer checks the receiving MSC threshold of the destination, and if the spammer has no MSC required for remittance, no email is sent.

(7) Refund: Assuming that all emails sent by the spammer are spam mails, the MSC sent by the spammer is not refunded.

(8) Revenue: A spammer earns a revenue b with a probability p for each spammer mail sent. The spammer earns the same amount of MSC as the revenue b through mining.

(9) Threshold update: A user who has received the email raises the threshold according to Formula (1).

(10) Loop for sending spam mails: Steps (6) to (9) are repeated T times. That is, each spammer is assumed to send T spammer emails per unit time.

(11) Loop for spammers: Steps (6) to (10) are repeated for all spammers.

(12) Loop in unit time: Steps (2) to (11) are repeated as one unit time. Time based on this is denoted as t.

In this example, the experiment was conducted with the ratio of users of the SAGA_{BC} system 1 (SAGA_{BC} utilization rate) set to 50%. Thus, experimental parameters were set as follows: Nu=100, Su=1, Nn=100, and Sn=0. Further, the revenue b earned by the spammer was calculated according to the following Formula (2).

$$b = 1000 ⋆ {C}^{- p} \qquad ( Formula 2 )$$

Here, C is a constant (27) and the value of p is a uniformly distributed random number satisfying 0<p<330.

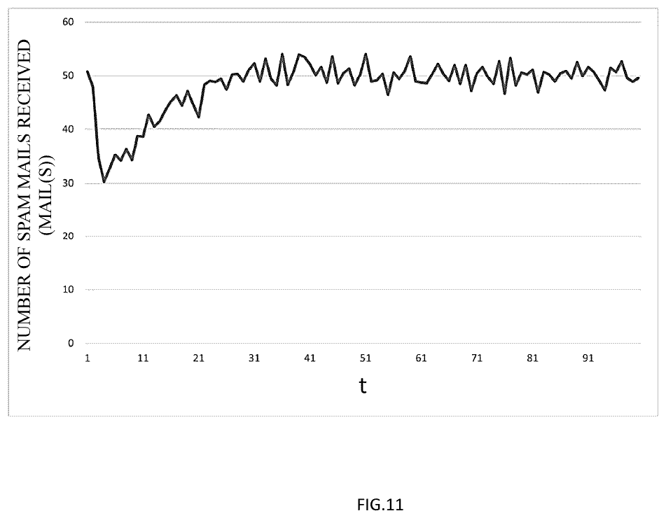

A result of the simulation is shown below. First, the number of spam mails received by the general users of the SAGA_{BC} system 1 when the utilization rate of the SAGA_{BC} system 1 is 50% in a conventional SAGA_{BC} system 1 that does not use the threshold adjustment algorithm in the information communication device 10 of the present invention, is shown in FIG. 11. FIG. 11 shows that if the threshold adjustment process is not performed when the utilization rate of the SAGA_{BC} system 1 is 50%, the number of spam mails received by the general users of the SAGA_{BC} system 1 tends to decrease until t=4, but gradually increases after that and stagnates at around 50 emails.

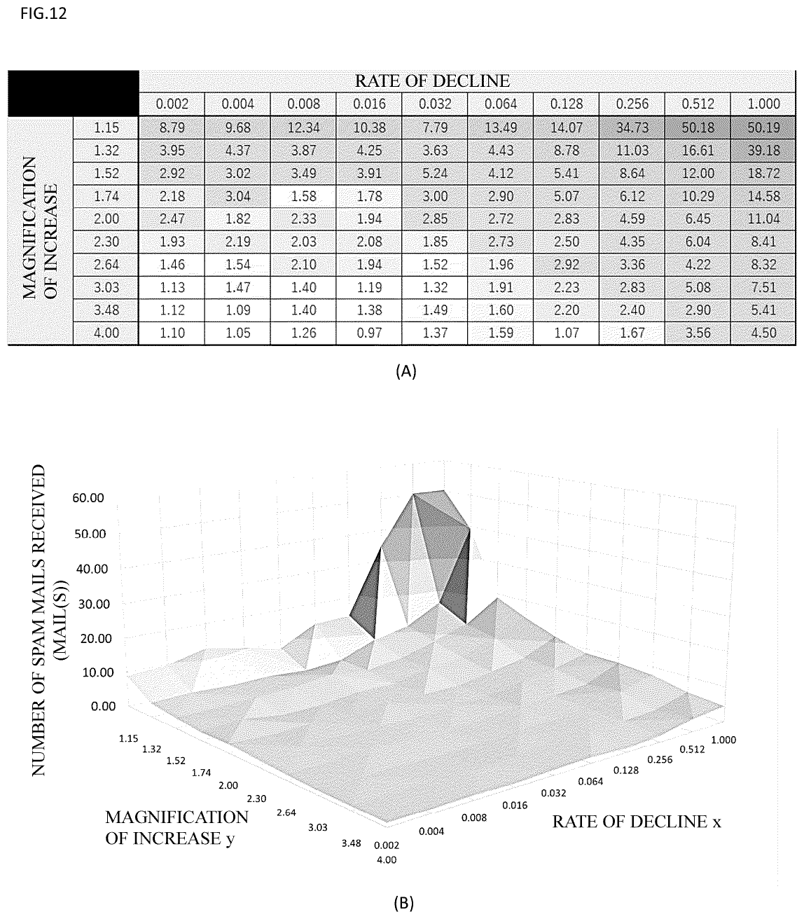

Next, the inventors verified the behavior when the threshold adjustment algorithm of the above-described Formula (1) was introduced. In the verification, the number of spam mails received by the general users of the SAGA_{BC} system 1 was compared by varying the rate of decline x in the receiving MSC threshold and the magnification of increase y in the receiving MSC threshold in Formula (1). The result of the verification is shown in FIGS. 12A and 12B. FIG. 12A shows the result in a tabular form, and FIG. 12B shows the result in a surface chart. Note that the values in the table shown in FIG. 12A and the values in the graph shown in FIG. 12B are the average values of the number of spam mails that arrived in the last 20 unit time in 100 trials. The verification results in FIGS. 12A and 12B have revealed that the number of spam mails received decreases when the rate of decline x in the receiving MSC threshold is small and the magnification of increase y in the receiving MSC threshold is large.

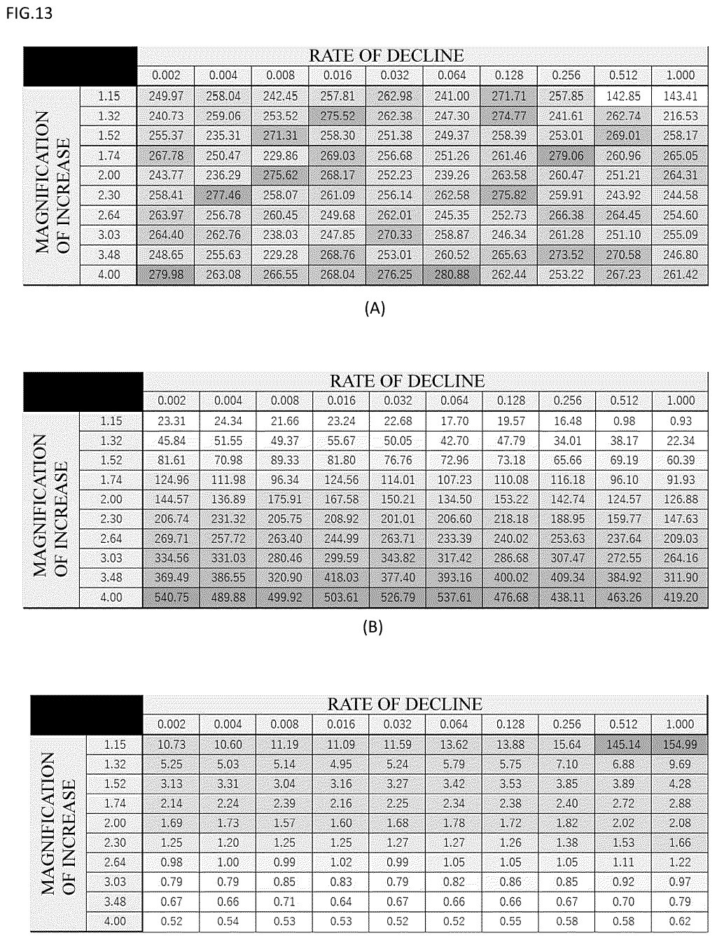

Next, the inventors focused on the receiving MSC threshold of the general users and the amount of MSC possessed by the general users when the rate of decline x in the receiving MSC threshold and the magnification of increase y in the receiving MSC threshold were varied. FIGS. 13A to 13C show information on a set of average amounts of cryptocurrency possessed by the general users and average receiving MSC thresholds. FIG. 13A shows average values of the final amounts of cryptocurrency possessed by the general users in 100 trials, FIG. 13B shows average values of the final receiving MSC thresholds of the general users in 100 trials, and FIG. 13C shows values each obtained by dividing the corresponding average final amount of cryptocurrency possessed by the general users in 100 trials by the corresponding average final receiving MSC threshold of the general users in 100 trials. If the (average final) receiving MSC threshold exceeds the (average final) amount of cryptocurrency possessed, that is, if a value in FIG. 13C is less than 1, an email cannot be sent even between the general users. In other words, this result has revealed that when the magnification of increase y is 2.64 or more, such a state in which (amount of cryptocurrency possessed)/(receiving MSC threshold) is less than 1 can occur as shown in FIG. 13C, and thus emails cannot be exchanged between the general users.

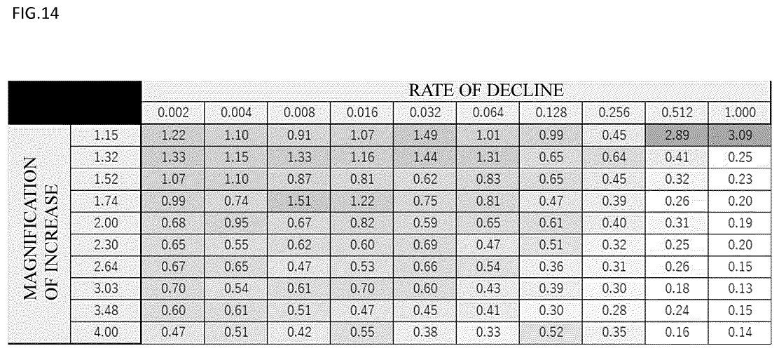

Setting the magnification of increase y to a value less than 2.64 enables the general users to send and receive emails between them as shown in FIG. 13. However, such a situation that the amount of cryptocurrency possessed divided by the receiving MSC threshold is about 1, that is, only one email can be sent and received at a time, would be considered to be problematic when considering daily usage of emails. Thus, (the number of spam mails received) divided by (the number of emails that can be sent simultaneously) is calculated and compared. Results of the calculation are shown in FIG. 14. From the results of FIG. 14, it can be concluded that to keep the number of spam mails received low while keeping the number of emails that can be sent and received between the general users of the SAGA_{BC}system 1 at a certain value, the rate of decline x should be 0.008 and the magnification of increase y should be 1.74 in the settings of this simulation.

From the above, it is revealed that in the conventional SAGA_{BC} system 1, it was difficult to prevent spam mails when the utilization rate of the SAGA_{BC} system 1 was 50%, but in the information communication device 10 of the present invention, using the receiving MSC threshold and varying the receiving MSC threshold according to the algorithm of Formula (1) make it possible to effectively prevent spam mails.

Further, it is revealed that appropriately setting the rate of decline and magnification of increase in the receiving MSC threshold in Formula (1) makes it possible to reduce reception of illegitimate emails due to spam emails, while operating the SAGA_{BC} system 1 stably so as not to cause any problems in sending and receiving emails by the general users.

### REFERENCE SIGNS LIST

1 SAGA_{BC} system
10 (10a, 10b) Information communication device
11 Mail server
11a Mail sending server
11b Mail receiving server
12 Blockchain
13 Internet
21 Input/output unit
22 Outgoing email creation unit
23 Email sending unit
24 Correspondence information storage unit
25 Private key storage unit
26 Remittance amount confirmation unit
27 Remittance control unit
28 Email receiving unit
29 Reception control unit
30 Incoming email processing unit
31 Refund control unit
32 Threshold control unit

1-7. (canceled)

8. An information communication device implemented in a computing system, the information communication device, comprising:
email sending unit configured to send an email from a first account to a second account;
remittance control unit generating a remittance transaction for sending a cryptocurrency from the first account to the second account when the email sending unit sends the email, and broadcasting the remittance transaction to a blockchain;
email receiving unit configured to receive an email sent from another a third account to the first account;
reception control unit accessing, when the email receiving unit receives the email, the blockchain to confirm a deposit status of the cryptocurrency from the third account to said-ene the first account;
email processing unit identifying whether the received email is a legitimate email or an illegitimate email, depending on whether a deposit amount of the cryptocurrency in the deposit status confirmed by the reception control unit is greater than or equal to a predetermined threshold, and performing predefined processing on the received email depending on an identified result; and
refund control unit generating, when the email processing unit has identified the received email as the legitimate email, a remittance transaction for sending the cryptocurrency from the first account to the third account, in accordance with a remittance transaction of the cryptocurrency generated when the email has been sent, and broadcasting the remittance transaction to the blockchain,
wherein the refund control unit further communicates electrically with a threshold control unit, the threshold control unit adjusts the threshold to be smaller when the refund control unit has performed refund processing of generating the remittance transaction and broadcasting the remittance transaction to the blockchain, and adjusts the threshold to be larger when the refund control unit has not performed the refund processing.

9. The information communication device according to claim 8, wherein the refund control unit determines whether to perform the refund processing in accordance with a type of operation on the email by a recipient who has received such the email, in addition to the identified result that the email processing unit has identified.

10. The information communication device according to claim 9, wherein the refund control unit performs the refund processing when the email processing unit has identified the received email as the legitimate email and the type of operation of the recipient belongs to one operation type including referring to, saving, and/or replying to the email, and does not perform the refund processing when the email processing unit has identified the received email as the illegitimate email or the type of operation of the recipient belongs to another operation type including discarding the email or identifying the email as a junk email.

11. The information communication device according to claim 8 wherein the threshold control unit adjusts the threshold to be smaller by subtracting the threshold when the refund control unit has performed the refund processing, and adjusts the threshold to be larger by multiplying the threshold when the refund control unit has not performed the refund processing.

12. The information communication device according to claim 8, wherein the threshold is set for each account or account type of a user.

13. An information communication program that causes a computer to function as:
email sending unit configured to send an email from a first account to a second account;
remittance control unit for generating a remittance transaction for sending a cryptocurrency from the first account to the second account when the email sending unit sends the email, and broadcasting the remittance transaction to a blockchain;
email receiving unit configured to receive an email sent from a third account to the first account;
reception control unit accessing, when the email receiving unit receives the email, the blockchain to confirm a deposit status of the cryptocurrency from the third account to the first account;
email processing unit identifying whether the received email is a legitimate email or an illegitimate email, depending on whether a deposit amount of the cryptocurrency in the deposit status confirmed by the reception control unit is greater than or equal to a predetermined threshold, and performing predefined processing on the received email depending on an identified result; and
refund control unit generating, when the email processing unit has identified the received email as the legitimate email, a remittance transaction for sending the cryptocurrency from the first account to the third account, in accordance with a remittance transaction of the cryptocurrency generated when the email has been sent, and broadcasting the remittance transaction to the blockchain,
wherein the refund control unit further communicates electrically with a threshold control unit, the threshold control unit adjusts the threshold to be smaller when the refund control unit has performed refund processing of generating the remittance transaction and broadcasting the remittance transaction to the blockchain, and adjusts the threshold to be larger when the refund control unit has not performed the refund processing.

14. The information communication program according to claim 13, wherein the refund control unit determines whether to perform the refund processing in accordance with a type of operation on the email by a recipient who has received such the email, in addition to the identified result that the email processing unit has identified.

15. The information communication program according to claim 13, wherein the refund control unit performs the refund processing when the email processing unit has identified the received email as the legitimate email and the type of operation of the recipient belongs to one operation type including referring to, saving, and/or replying to the email, and does not perform the refund processing when the email processing unit has identified the received email as the illegitimate email or the type of operation of the recipient belongs to another operation type including discarding the email or identifying the email as a junk email.

16. The information communication program according to claim 13, wherein the threshold control unit adjusts the threshold to be smaller by subtracting the threshold when the refund control unit has performed the refund processing, and adjusts the threshold to be larger by multiplying the threshold when the refund control unit has not performed the refund processing.

17. The information communication program according to claim 13, wherein the threshold is set for each account or account type of a user.

18. The information communication device according to claim 9, wherein the threshold control unit adjusts the threshold to be smaller by subtracting the threshold when the refund control unit has performed the refund processing, and adjusts the threshold to be larger by multiplying the threshold when the refund control unit has not performed the refund processing.

19. The information communication device according to claim 9, wherein the threshold is set for each account or account type of a user.

20. The information communication program according to claim 8, wherein the third account is the same as the second account.

21. The information communication program according to claim 8, further comprising the threshold control unit.
